(19) United States
(12) Patent Application Publication
(10) Pub. No.: US 2014/0089124 A1
(43) Pub. Date: Mar. 27, 2014

(54) Dynamic Product Content Generation

(71) Applicant: Google, Inc., (US)

(72) Inventors: Vikas Jha, Hillsborough, CA (US); Vishal Goenka, Santa Clara, CA (US); David Monsees, San Francisco, CA (US); Jayavel Shanmugasundaram, Santa Clara, CA (US); Fred Bertsch, Belmont, CA (US); Dongmin Zhang, Sunnyvale, CA (US)

(73) Assignee: Google Inc., Mountain View, CA (US)

(21) Appl. No.: 13/627,584

(22) Filed: Sep. 26, 2012

(51) Int. Cl. G06Q 30/06; G06F 17/30

(52) U.S. Cl. CPC G06Q 30/0623; G06F 17/30964
USPC 705/26.3; 707/723; 707/724

(57) ABSTRACT

Methods, systems, and apparatus, including computer programs encoded on a computer storage medium, for building and serving dynamic product advertisements. A request is received for content including request data. Product data is accessed representing multiple product records, each associated with a different product. Multiple matching rules are applied to each of the product records in order to identify a subset of product records satisfying the matching rules. For each of the product records satisfying the matching rules, multiple scores are generated, each score representing the relevance of the product to the request based on the request data. The scores are aggregated. One or more of the product records are selected based at least on the aggregate scores. A dynamic product content item is served in response to the request featuring the products associated with the one or more selected product records.

### BACKGROUND

This specification relates to information presentation.
The Internet enables access to a wide variety of content, and includes a large and increasingly diverse audience. The consumer base formed by visitors to various websites is recognized as being an important audience for delivery of content, such as advertising.

A web page can be delivered by a publisher and include one or more slots for presentation of sponsored content. A request for content can be delivered to a content management system and one or more sponsored content items can be served to fill the one or more slots. Similarly, search results can as well be delivered along with one or more sponsored content items that are relevant to the search request, the requestor or other considerations. Static content, that is content that does not vary based on the serving request, can be delivered responsive to these received requests.

### SUMMARY

In general, one innovative aspect of the subject matter described in this specification can be embodied in methods that include the actions of receiving a request for content including request data; accessing product data representing a plurality of product records, each product record associated with a different product; applying a plurality of matching rules to each of the plurality of product records in order to identify a subset of product records satisfying the plurality of matching rules; for each of the product records of the subset of product records satisfying the plurality of matching rules, generating a plurality of scores, each score representing the relevance of the product to the request based on the request data, and generating an aggregate score based on the plurality of scores; selecting one or more of the product records based at least on the aggregate scores; and serving a dynamic product content item in response to the request, the dynamic product content item featuring the products associated with the one or more selected product records. Other embodiments of this aspect include corresponding systems, apparatus, and computer programs, configured to perform the actions of the methods, encoded on computer storage devices.

These and other embodiments can each optionally include one or more of the following features. Each product record may include a product title, product image, and a product description. The dynamic product content item may include at least one of the product title, product image, or product description of each of the selected product records.

The dynamic product content item may be submitted as one of a plurality of content items to be ranked within an auction and served based on the dynamic product content item's placement in the auction.

Generating a plurality of scores for each product record may include generating a score representing a historical interaction of users with content items or one or more internet resources featuring the product associated with the product record. The request data may include one or more user attributes, and the score may represent a historical interaction of users identified as sharing the one or more user attributes. The request data may include data uniquely identifying a user associated with the request, and the score may represent historical interaction of users identified as having a connection on a social network with the user associated with the request.

The request data may include a location, and the product records may include locations. Generating a plurality of scores for each product record may include generating a score representing a proximity of the location included in the request data to at least one of the locations included in the product record. Generating a plurality of scores for each product record may include generating a score representing a relevance of the product associated with the product record to an environmental condition associated with the location included in the request data.

The request data may include one or more keywords. The keywords may be associated with content of a webpage on which content items served in response to the request are to be presented, or with a search query for which content items in response to the request are to be presented on a search results page responsive to the search query. Each product record may include one or more keywords. Generating a plurality of scores for each product record may include generating a score representing a relevance of the one or more keywords included in the request data to the one or more keywords included in the product record.

Particular embodiments of the subject matter described in this specification can be implemented so as to realize none, one or more of the following advantages. Dynamic sponsored content items can be generated responsive to received requests, wherein the dynamic sponsored content items can be highly relevant to a requesting user. Content sponsors do not have to generate and manage individual product content items within a campaign, but can instead manage product lists while the content items are generated dynamically. Product-specific traits can be matched to user traits, interest, and history more easily than with static content.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which dynamic product content items are built and delivered.

FIG. 2 is a block diagram showing components of a content management system that may be used in the building and delivery of dynamic product content items.

FIG. 3 is a flowchart illustrating an exemplary process 300 for selecting products for a dynamic content item.

FIG. 4 is an exemplary dynamic product content item.

FIG. 5 shows an example of a generic computer device and a generic mobile computer device, which may be used with the techniques described here. Like reference numbers and designations in the various drawings indicate like elements.

### DETAILED DESCRIPTION

An internet content delivery system can include dynamic product content items as one of its available content types. Rather than submitting content items featuring each product, a content sponsor submits a product catalog. The system can generate a dynamic content item using any product (or group of products) in the catalog, based on a process that evaluates the suitability of each product and selects one or more particular products for inclusion in a content item. While reference is made below to the dynamic content item being of the form of an advertisement (or “ad”), other forms of sponsored content are possible.

The content delivery system identifies an opportunity to present one or more content items to a user (e.g., an internet user). The content delivery system or associated system can be used to build a dynamic product content item responsive to a received request. Once built, the dynamic product content item may compete for space with other content types.

A dynamic product content item can be built by selecting one or more products from a sponsor's product list and assembling a content item featuring the selected product or products. The products are matched to the specific event/request that triggered the request for content and the user that the content would be shown to.

In some implementations, products are selected by a multi-step selection process. First, a subset of products is identified. The subset of products can be identified based at least in part on applying a set of rules to a product catalog in order to locate matches. Each identified product in the subset of products is scored by, for example, a set of scoring modules. The best-scoring products are then evaluated, for example based on their projected performance, and the products selected based on this evaluation are used to generate the dynamic content item.

In some implementations, each stage of the selection process may consider the potential products and aspects of the content delivery event, such as the user's attributes, preferences, and history, as well as the content of a web page or search results page associated with a given request and other factors. As mentioned above, dynamic content items may still have to compete with each other and with other content types after they are assembled (e.g., in an auction). In some implementations, dynamic content items are constructed after a potential content item is evaluated as being a winner of such an auction, hence making the overall process more efficient. In some implementations, the dynamic content items are constructed prior to comparison with other candidate content items.

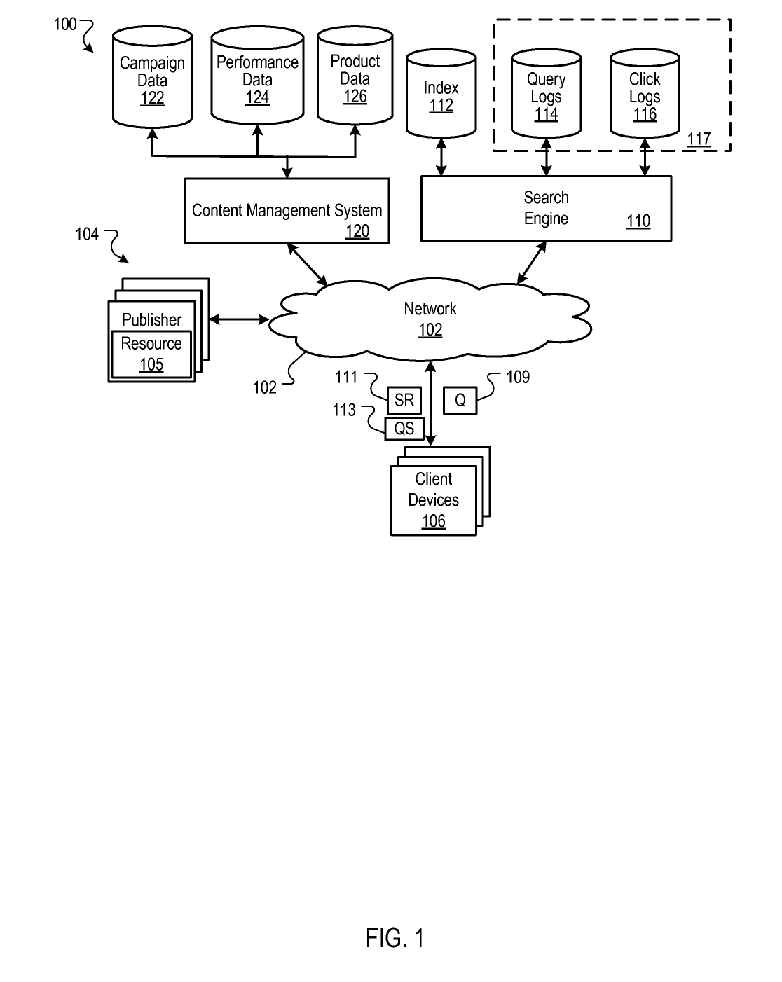

FIG. 1 is a block diagram of an example environment 100 in which dynamic product content items are constructed and delivered. A computer network 102, such as a local area network (LAN), wide area network (WAN), the Internet, or a combination thereof, connects publisher web sites 104, user devices 106, and the search engine 110, and a content management system 120. The online environment 100 may include many thousands of publisher web sites 104 and user devices 106.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a content publisher, which is an entity that controls, manages and/or owns the website 104.

A resource is any data that can be provided by the publisher 104 over the network 102 and that is associated with a resource address. Resources include HTML pages, word processing documents, and portable document format (PDF) documents, images, video, and feed sources, to name just a few. The resources can include content, such as words, phrases, pictures, and so on, and may include embedded information (such as meta information and hyperlinks) and/or embedded instructions (such as JavaScript scripts).

A user device 106 is an electronic device that is under the control of a user and is capable of requesting and receiving resources over the network 102. Example user devices 106 include personal computers, mobile communication devices, set top boxes, televisions and other devices that can send and receive data over the network 102. A user device 106 typically includes a user application, such as a web browser, to facilitate the sending and receiving of data over the network 102. The web browser can enable a user to display and interact with text, images, videos, music and other information typically located on a web page at a website on the world wide web or a local area network.

To facilitate searching of these resources 105, the search engine 110 can identify the resources by, for example, crawling the publisher web sites 104 and indexing the resources provided by the publisher web sites 104. The indexed and, optionally, cached copies of the resources, are stored in an index 112.

The user devices 106 submit search queries 109 to the search engine 110. The search queries 109 are submitted in the form of a search request that includes the search request and, optionally, a unique identifier that identifies the user or user device 106 that submits the request. The unique identifier can be data from a cookie stored at the user device, or a user account identifier if the user maintains an account with the search engine 110, or some other identifier that identifies the user device 106 or the user using the user device 106.

In response to the search request, the search engine 110 can identify (e.g, using the index 112) resources that are relevant to the queries. The search engine 110 identifies the resources in the form of search results 111 and returns the search results to the user device 106 in a search results page resource. A search result is data generated by the search engine 110 that identifies a resource that satisfies a particular search query, and includes a resource locator for the resource. An example search result can include a web page title, a snippet of text extracted from the web page, and the URL of the web page.

The search results can be ranked based on, for example, scores related to the resources identified by the search results, such as information retrieval (“IR”) scores, and optionally a separate ranking of each resource relative to other resources (e.g., an authority score). The search results are ordered according to these scores and provided to the user device according to the order. Other content as will be described below can be delivered along with the search results.

The user devices 106 receive the search results pages and render the pages for presentation to users. In response to the user selecting a search result at a user device 106, the user device 106 requests the resource identified by the resource locator included in the selected search result. The publisher of the web site 104 hosting the resource receives the request for the resource from the user device 106 and provides the resource to the requesting user device 106.

In some implementations, the queries 109 submitted from user devices 106 can be stored in query logs 114. Click data (e.g., interaction data) for the queries and the web pages referenced by the search results can be stored in click logs 116. The query logs 114 and the click logs 116 define search history data 117 that includes data from and related to previous search requests associated with unique identifiers. The click logs define actions taken responsive to search results provided by the search engine 110. The query logs 114 and click logs 116 can be used to map queries submitted by the user devices to web pages that were identified in search results and the actions taken by users (i.e., that data are associated with the identifiers from the search requests so that a search history for each identifier can be accessed). The click logs 116 and query logs 114 can thus be used by the content management system 120 to determine the sequence of queries submitted by the user devices, the actions taken in response to the queries, and how often the queries are submitted.

The content management system 120 facilitates the provisioning of third party sponsored content (e.g., advertisements or “ads”) with the resources 105. In particular, the content management system 120 allows content sponsors to define selection criteria that take into account, for example, attributes of the particular user to provide relevant content to the users. Example selection criteria include keywords. A content sponsor can provide a bid for one or more keywords that are present in either search queries, webpage content or a content request. Third party content (e.g., content items) that is associated with keywords having bids that result in a slot being awarded in response to an auction is selected for presentation in the slots. In some implementations, other entities such as content publishers or search engine operators may provide selection criteria rather than (or in addition to) content sponsors.

When a user of a user device 106 interacts with a presented content item, the user device 106 generates a request for a landing page associated with the content item, which may be of the form of a webpage of the content sponsor.

These targeted content items can be provided for many different resources, such as the resources 105 of the publishers 104, and on a search results page resource. For example, a resource 105 from a publisher 104 can include instructions that cause the user device to request one or more content items from the content management system 120. The request can include a publisher identifier and, optionally, keyword identifiers related to the content of the resource 105. The content management system 120, in turn, provides selected content to the particular user device.

With respect to a search results page, the user device renders the search results page and sends a request to the content management system 120, along with one or more keywords related to the query that the user provide to the search engine 110. The content management system 120, in turn, provides selected content to the particular user device.

The content management system 120 includes a data storage system that stores campaign data 122, performance data 124, and product data 126. The campaign data 122 stores content items (e.g., creatives), selection information, and budgeting information for content sponsors. The performance data 124 stores data indicating the performance of the content items that are served. Such performance data can include, for example, click through rates for content item, the number of impressions for the content item, and the number of conversions for the content item. Other performance data can also be stored. The product data stores product information for content sponsors. Such product data can include product information such as a product names, descriptions, images, and categories, as well as product location and availability. The product data 126 may be received from a product feed provided by a content sponsor or may be generated by accessing an online store or other merchant system. Other relevant commercial data may be stored along with the product data 126.

The campaign data 122, the performance data 124, and the product data 126 are used as input parameters to a content selection process. In some implementations, the content management system 120, in response to each request for content, can conduct an auction to select candidate content items for evaluation responsive to a received request. The content items may include both static content pulled directly from the campaign data 122 and dynamic product content items that are built using the product data 126. The candidate content items are ranked according to, for example, a score that, in some implementations, is proportional to a value based on a content item bid and one or more parameters specified in the performance data 124. One or more of the highest ranked content items resulting from the auction can be selected and provided to the requesting user device. In some implementations, no auction is conducted, and instead the content management system 120 can select one or more content items based on a reservation model and in consideration of an urgency to supply respective ones of the content items in inventory based on, for example, a satisfaction index.

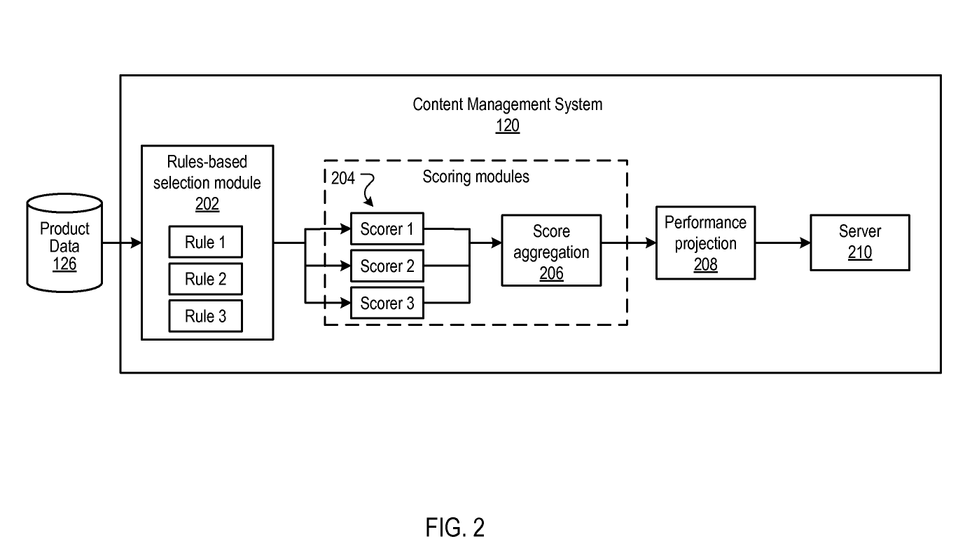

FIG. 2 is a block diagram showing components of a content management system 120 that may be used in the building and delivery of dynamic product content items. The system 120 may select products from product data 126 using a rules-based selection module 202. The selected products may be submitted to one or more of a plurality of scoring modules 204, each of which may submit a score for each product to a score aggregation module 206. The top-scoring products may then be submitted to a performance projection module 208, which may select products based on projected performance and one or more other factors. The server 210 receives the selected products and builds a dynamic product content item, which may then be handled along with other static and dynamic content items in order to select one or more items for delivery.

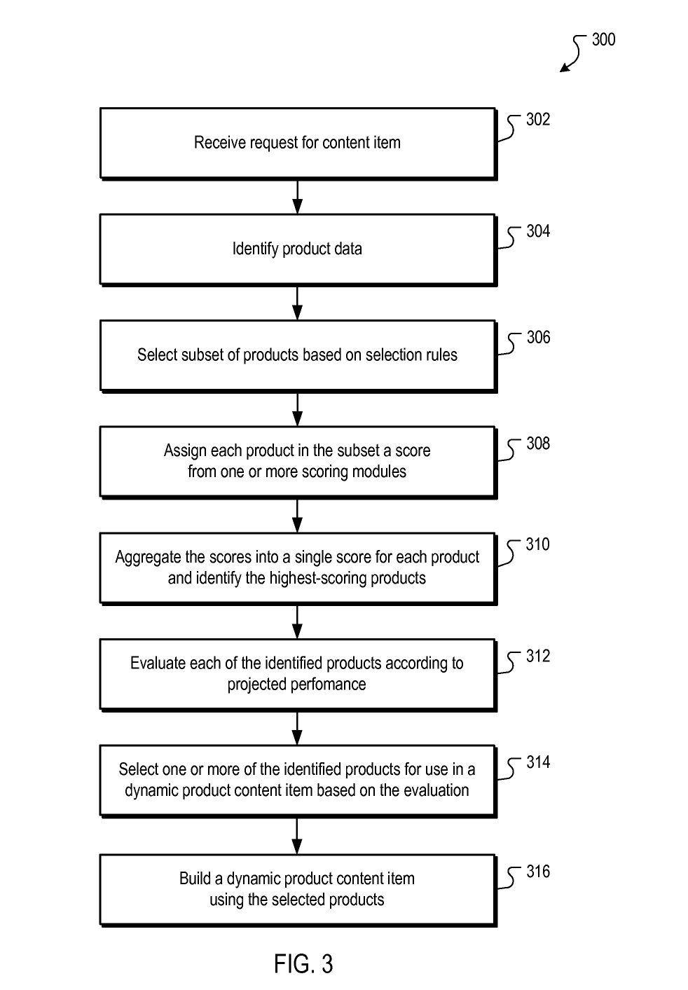

FIG. 3 is a flowchart illustrating an exemplary process 300 for selecting products for a dynamic content item.

A request for a content item is received (302). As explained above, the request may be submitted in response to a user accessing published content 104 with space for including one or more other content items (e.g., sponsored content items). The request may come directly from a user device or alternatively be associated with a search query that was submitted to a search engine 110.

The request may include information about the user, as well as information about the circumstances of the request. In some implementations, the information about the user may include demographic information such as the user's age, gender, location, or occupation. Information about the user may also include the user's browsing and shopping history, browsers and devices associated with the user's internet activity, and other accounts associated with the user. Additional information relevant to tailoring content to the user may also be included in the request. Various mechanisms may be used to anonymize the information and protect the user's privacy, such as omitting the user's name, mailing address, or account name and assigning a randomly-generated user ID.

The systems and techniques described here may, in appropriate instances, be provided with mechanisms by which users may be informed about and control information that is collected about their use of the systems. For example, in certain implementations, it may be appropriate to provide users with the opportunity to view the types of information collected, and to permit users to opt in or opt out of various systems that may collect information. Also, the storage of information by the systems may, in certain circumstances, be limited to certain time frames, such as storing information only for a predetermined number of hours/days/months. Moreover, information that is stored and/or provided to third parties may be aggregated prior to any sharing or otherwise anonymized or affected so as to remove personally identifiable information from the data. The particular approaches that are employed with respect to user data may vary depending on the type of data and the type of services being provided, recognizing that in some circumstances, such steps may limit the usability of such systems by a user.

In addition to information associated with the user, the specifics of the circumstances of behind or associated with the request itself may also be included. In some implementations, this information may include the content of the web page or search query associated with the request, the time and location of the request, the client and device on which any resulting content will be presented, and other collected information.

Product data is identified (304). In some implementations, the product data 126 may be in the form of a product feed or product catalog submitted by the product sponsor for use by the content management system 120 in building dynamic product content items. Alternatively, the product data 126 may be determined or generated as required, such as by acquiring the data from the content sponsor's website.

In some implementations, the product data may be in the form of product records. Each product record may include a unique product ID, a product name, an image, a description, one or more categories, and/or relationships to other products.

A subset of products is selected based on a set of one or more selection rules (306). In some implementations, a plurality of different selection rules may be used, and each of the rules may be evaluated to determine one or more additional products that can be added to the selected subset for additional processing. In some implementations, the selection rules may be used together and only products that satisfy multiple rules can be selected.

In some implementations, the rules used in order to select a subset of products may be provided to one or more of the scoring modules 204. For example, a rule may require that one or more of the scoring modules 204 returns a non-zero value or a value above a certain threshold when a given product is scored in order for that product to be selected. The rules-based selection may use any of the data or processes further described below with respect to the scoring modules, including geolocation data and distance calculations, interaction data for both content items and product sites, data for select groups including user demographics, social networking data, content keyword matching, and any other data relevant to the initial selection of products for further scoring and evaluation.

A sponsor's product catalog may include hundreds of different products represented within the product data 126. In some implementations, the rules-based selection module 202 may use rules that are relatively quick to implement/process within the content management system 120 framework so that the subset of products may be selected in an efficient manner.

In some implementations, the selection rules used in this step 306 of the process 300 may be specified by a content sponsor. This would allow a content sponsor to limit the products under consideration to specific criteria.

Each of the selected products is scored, for example, by one or more of the scoring modules 204 (308). For each product, the scoring modules 204 each generate a score based on one or more attributes in the product record and one or more attributes of the content request. The score may be based on traits of the user associated with the request, the content associated with the request, the circumstances of the request, and/or other factors.

In some implementations, each scorer may return a score between 0 and 1 which roughly represents how relevant the particular product is to the particular request along the metric represented by the scorer.

As an example, an interaction scorer may evaluate the product's popularity when included in previous dynamic product content items. The popularity information may be included in the performance data 124 accessed by the content management system 120. Interaction may take various forms, including mouse-over events, click events, or conversion events. In some implementations, the interaction scorer may return a simple fraction representing the proportion of the number of content items featuring the product that are interacted with to the total number of content items featuring the product that are shown. More complicated scores are also possible, such as scoring more highly for conversion events than for click events, or favoring the interaction rate for highly-ranked product content items or content items where the product is shown first.

In some implementations, a user interaction scorer may evaluate the product's popularity as explained above, but using only data with one or more particular traits matching the user. For example, if the user is a female in the 20-29 age range, a user interaction scorer may return a score based only on the interaction data for users identified as females in the 20-29 age range. Multiple different scorers may be used to select different user or request attributes, or a single scorer may return a score based on the interaction data for multiple different attributes matching the received content request. The user interaction scorer may be distinct from the content interaction scorer described above, or the two may be integrated into a single scoring module 204.

As another example, a product interaction scorer may evaluate the product's popularity on one or more web sites (such as popularity on a content sponsor's web site). Interaction may take various forms, including page views, hover time, hover, view time, clicks, sales or other interaction events. In some implementations, the product interaction scorer may return a fraction that defines the popularity of the given product relative to other products; for example, each product could be scored according to the ratio of the number of page views for that product to the number of page views of the most viewed/interacted with product. Accordingly, the product with the most views/interactions could be given a score of 1, while products without views or interactions would have a score of 0. Other metrics could be used, including a score based on a product's sales rank, profit amount, revenue or other metrics.

In some implementations, a product interaction scorer may base a product interaction score on interactions fitting additional criteria matched to the received request. For example, where the request is made from a mobile device, a user interaction scorer may return a score based only on product interactions identified as coming from mobile devices. Again, multiple different scorers may be used based on different attributes, some or all of which may be combined in a same scoring module 204.

As another example, a profitability scorer may evaluate the product's value to the content sponsor. A profitability score may take into account the profit margin of a product sale, such that products that return a higher proportional or absolute profit receive a higher score. In some implementations, a product's list price may be used in determining a profitability score rather than or in addition to its profit margin. In some implementations, these factors may be combined with another scoring module 204; for instance, the profitability of a product may be included as a factor in its interaction score or product interaction score as described above.

As another example, a geolocation scorer may be used to score the local availability of the product based on the location of the user. In some implementations, each product record may include information on locations where the product is available. For example, product availability information may be in the form of addresses of retail locations where the product can be purchased. The request may also have or be associated with a location, and the distance between the product locations and the location associated with the request may be used to generate or modify a score.

In some implementations of a geolocation scorer, a maximum distance could be specified, such as 100 miles. A product with no availability within 100 miles of the request location could be assigned a score of 0. For products with one or more availability locations within 100 miles of the request location, a score could be assigned based on the distance d between the request location and the closest product availability location. The score could be given as (100−d)/100, which would generate a score of 0 at d=100 miles away and a score of 1 at d=0 miles away (the request location coincides with a location of product availability).

In some implementations, the product data 126 may include inventory data for various locations which may be updated regularly or periodically. A geolocation scorer may factor the available inventory at nearby locations when generating a score. When an inventory at a given location is shown as 0 (or, in some implementations, is shown to be below a specified nonzero threshold), that location may not be used as a location of availability for that product. Where inventory data is available, a geolocation scorer may score products more highly that are highly stocked in a location than products that are sold out or nearly sold out in other locations.

In some implementations, the geolocation of the request may also be used in conjunction with user interaction and product interaction data in order to produce a combined/or aggregate score. For example, product interaction data or user interaction data limited to users identified as located with 100 miles of a given request location may be used to generate an aggregate score. A weighting system can be used to weight the importance of location (e.g., distance), availability, and interaction data in determining an aggregate score.

As another example, a content keyword scorer may evaluate the relevance of a product based on the content of the page associated with a given request. Each product may be associated with a variety of keywords. For example, words found in the title, description, and category fields of each product record may be identified as keywords for that product. These words may be matched against the content of the page or keywords associated with the received request by one or more of the scoring modules 204 to generate a score. The degree or quality of the match may be included in the scoring algorithm.

As another example, an email keyword scorer may evaluate the relevance of a product's identified keywords against keywords identified from a user's email. This may be used, for example, when the request is for a content item to be served within a user's email client. In some implementations, the keyword scorer can also be used to identify keywords from other content associated with the user, such as the user's documents or online communications.

As another example, a search history keyword scorer may evaluate the relevance of a product's identified keywords against keywords identified from a user's search history. The search history may be associated with a search engine, or any other search records. In some implementations, particular weight may be applied to searches performed on the content sponsor's site.

As another example, a scorer may generate a score based on a user's history in viewing pages on the content sponsor's site. For example, a scoring module 204 may include logic for identifying products related to a product a user has previously viewed. Related products may be identified based on matching keywords found in the records associated with both products, based on the products belonging to a common category, or based on a sponsor-specified relationship between the products.

In addition to the user's own product history, a scorer may generate a score based on the viewing or purchasing history of other users with a relationship to the user. For example, the history of users identified by a social networking site as being networked with a user may be used to score products in relation to a request received from the user. Where a social network is used, a direct connection between the two users within the network may be scored more significantly than an indirect connection.

As another example, an environmental scorer may be used to select products based on, for example, the weather associated with a location from whence the request was generated. For example, where the geolocation of the request is known, the current or projected future weather conditions of that geolocation can be identified. In some implementations, the sponsor may provide weather tags for certain products to be shown based on certain weather conditions. An example of weather tags may be ‘hot’, ‘cold’, ‘sun’, ‘rain’, ‘wind’, and ‘snow’. The severity of the weather condition may affect the score; for example, a higher temperature may result in a higher weather score for a ‘hot’ product, while the percentage chance of precipitation may be reflected in the weather score for a ‘sun,’ ‘rain,’ or ‘snow’ product.

The scores from each scoring module 204 can be aggregated into an aggregate score, which may weight the scores according to their relative importance to the overall relevance of the product to the request (310). For example, where four scoring modules 204 return scores s₁ through s₄, a linear equation may be used:

aggregate score=w1*s1+w2*s2+w3*s3+w4*s4

In this case, each score s1 through s4 is weighted by a particular weighting factor w1 through w4, which may be specified by an sponsor or automatically generated by the content management system 120. Other functions, such as including polynomial and exponential elements, may also be used to create an aggregate score from the individual scoring modules 204.

One or more products having the highest aggregate scores are identified for further evaluation. In some implementations, the number of products that are identified for further evaluation is dependent on the efficiency of the content management system 120. Where evaluating the identified products is resource-intensive, only a relatively small number of the selected subset of products may be identified for evaluation. For example, the number of identified products may only be a small multiple of the number of products featured in the dynamic product content item. In some implementations, rather than a set number of products being evaluated, the system 120 evaluates products with aggregate scores above a threshold level. In some implementations, if not enough products have aggregate scores above a threshold level, the dynamic product content item building process may be aborted at this step.

In some implementations, the identified products are evaluated according to their projected performance (312). In some implementations, this evaluation may involve generating a predicted click-through rate (or pCTR) for each product in the context of the received request. Various algorithms for predicting a click-through rate for content are well-known, and the performance projection module 208 may use data representing the past performance of products in content items (e.g., ads) in order to generate pCTR values. The performance projection module 208 may use demographic selection data, request data, user and product interaction history data in evaluating the products. In some implementations, the pCTR values, which are only generated for a relatively small subset of the sponsor's available products, may involve a correspondingly higher level of processing. The evaluation process may include machine learning and other automated techniques.

When the dynamic product content item includes more than one product slot, in some implementations, combinations of products may be evaluated as a group in order to determine which group of products are most effective. Fewer products may be identified for evaluation in situations where the number of permutations of product groups may require significant resources. For example, evaluating twelve products to serve in three slots in a particular configuration would require evaluating over one thousand permutations. Because of the resource-intensive nature of these group evaluations, in some implementations, individual products may be evaluated and selected rather than groups of products.

Once the identified products are evaluated, one or more of the identified products are selected for use in the dynamic product content item (314). For example, the performance projection module 208 can select the number of products for which there are slots in the dynamic product content item.

In some implementations, the performance projection module 208 may not necessarily select the product or products with the highest pCTR. For example, some percentage of the time, one or more of the products may be identified as not having sufficient recent data, and may be selected “out of turn” in order to provide additional information. Similarly, newly added products may be selected for the content item in order to provide sufficient data, and may use a default pCTR until sufficient data is generated.

A dynamic product content item is constructed using the selected products (316). The dynamic content item may be constructed based on a template previously selected. Each of the products selected may be included, along with titles, images, and descriptions of the products. The construction may be performed by server 210.

In some implementations, the manner of product selection may influence the build of the dynamic product content item. For example, in some implementations, the particular scores from the individual scoring modules 204 may be passed through to the server 210 for use in the content-building step 316. A product with a high score in one area may cause an aspect of the content item to reflect that area, such as displaying text relevant to the topic of the particular scorer. Multiple examples of content item text tailored to high scores from different scorers are illustrated in the exemplary dynamic product content item 400.

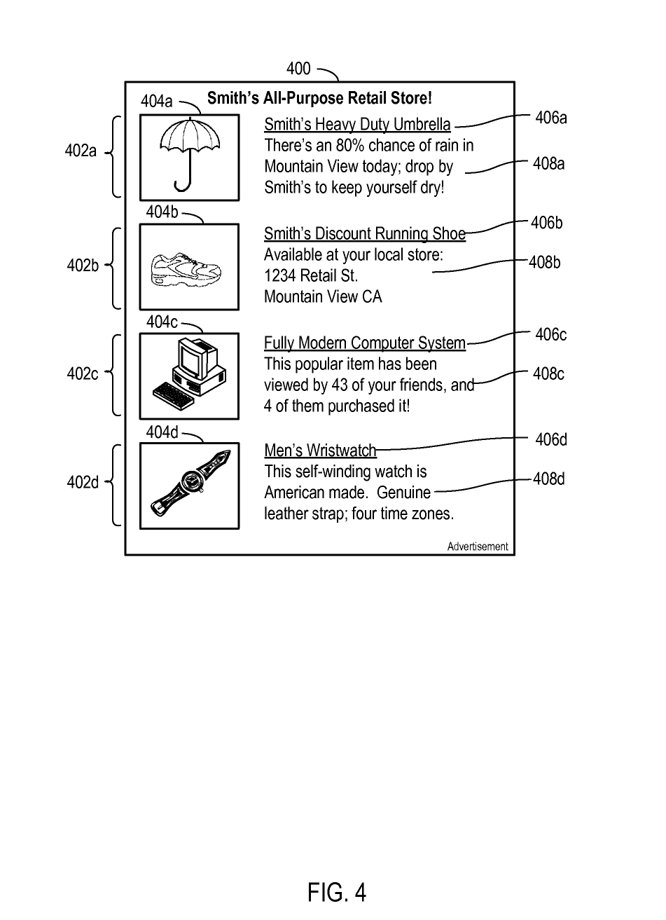

FIG. 4 is an exemplary dynamic product content item 400 with four product slots 402a-d. Each product slot 402a-d includes a title 404a-d and image 406a-d, as well as a text block 408a-d. In the implementation shown, the text block 408a-d differs according to the product's scores determined during the product selection process.

The dynamic product content item 400 was constructed in response to a request from a user in Mountain View accessing an informational page about time zones. In this example, each of the four product slots 402a-d is filled with content based on a high score from a different scoring module 204.

The first product slot 402a is filled by an umbrella product that received a high score from a weather scorer. The text 408a gives the relevant portion of the forecast as well as the user's location.

The second product slot 402b is filled by a shoe product that received a high score based on local product availability. The text 408b gives the location of the local store.

The third product slot 402c is filled by an electronics product that received a high score based on product interaction among members of the user's social network. The text 408c relates the popularity of the item among the user's contacts.

The fourth product slot 402d is filled by a wristwatch product that received a high score based on content keywords, because the content page associated with the request features the keywords “time zone” prominently and also discusses “wristwatch” in passing. The text 408d is the product description as retrieved from the product data 126.

Once the dynamic product content item is constructed, the server 210 may include the dynamic product content item with other content items in an auction in order to determine which one or more of the content items to display responsive to a received request. Because the dynamic product content item is competing with other content items, which may include both static and dynamic content, there is no guarantee that the dynamic content item will be displayed. When the dynamic content item is displayed, then any interaction (or lack thereof) with the content item by the user may result in an update of the performance data 124 for serving future requests.

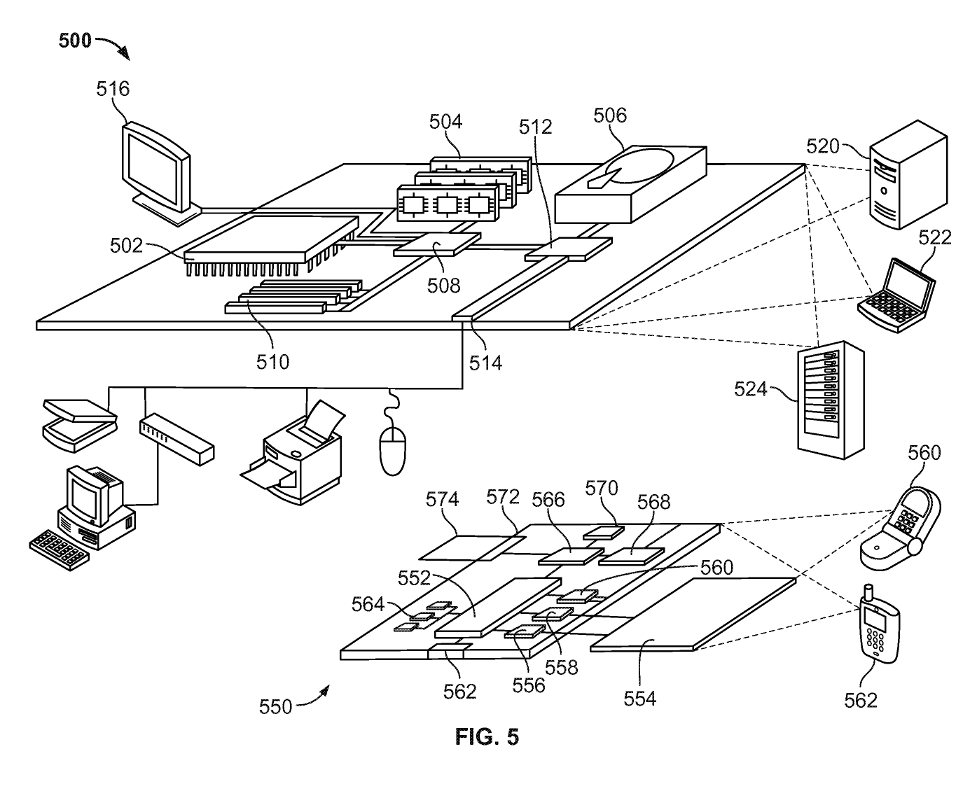

FIG. 5 shows an example of a generic computer device 500 and a generic mobile computer device 550, which may be used with the techniques described here.

Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, tablet computers and other similar computing devices. The components shown here, their connections and relationships, and their functions, are meant to be exemplary only, and are not meant to limit implementations of the techniques described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a request for content, the request including request data;
accessing product data representing a plurality of product records, each product record associated with a different product;
applying a plurality of matching rules to each of the plurality of product records in order to identify a subset of product records satisfying the plurality of matching rules;
for each of the product records of the subset of product records satisfying the plurality of matching rules, generating a plurality of scores, each score representing the relevance of the product to the request based on the request data, and generating an aggregate score based on the plurality of scores;
selecting one or more of the product records based at least on the aggregate scores; and
serving a dynamic product content item in response to the request, the dynamic product content item featuring the products associated with the one or more selected product records.

2. The method of claim 1,
wherein each product record includes a product title, product image, and a product description, and
wherein the dynamic product content item includes at least one of the product title, product image, or product description of each of the selected product records.

3. The method of claim 1, further comprising:
submitting the dynamic product content item as one of a plurality of content items to be ranked within an auction;
wherein the dynamic product content item is served based on the dynamic product content item's placement in the auction.

4. The method of claim 1, wherein, for each product record of the subset of product records, generating a plurality of scores comprises:
generating a score representing a historical interaction of users with content items featuring the product associated with the product record.

5. The method of claim 4,
wherein the request data includes one or more user attributes; and
wherein the score represents a historical interaction of users identified as sharing the one or more user attributes.

6. The method of claim 1, wherein, for each product record of the subset of product records, generating a plurality of scores comprises:
generating a score representing historical interaction of users with one or more internet resources featuring the product associated with the product record.

7. The method of claim 6,
wherein the request data includes one or more user attributes; and
wherein the score represents a historical interaction of users identified as sharing the one or more user attributes.

8. The method of claim 6,
wherein the request data includes data uniquely identifying a user associated with the request; and
wherein the score represents historical interaction of users identified as having a connection on a social network with the user associated with the request.

9. The method of claim 1,
wherein the request data includes a location;
wherein the product records include locations; and
wherein, for each product record of the subset of product records, generating a plurality of scores comprises generating a score representing a proximity of the location included in the request data to at least one of the locations included in the product record.

10. The method of claim 1,
wherein the request data includes a location; and
wherein, for each product record of the subset of product records, generating a plurality of scores comprises generating a score representing a relevance of the product associated with the product record to an environmental condition associated with the location included in the request data.

11. The method of claim 1,
wherein the request data includes one or more keywords associated with at least one of (i) content of a webpage on which content items served in response to the request are to be presented and (ii) a search query, for which content items in response to the request are to be presented on a search results page responsive to the search query;
wherein each product record includes one or more keywords; and
wherein, for each product record of the subset of product records, generating a plurality of scores comprises generating a score representing a relevance of the one or more keywords included in the request data to the one or more keywords included in the product record.

12. A system comprising:
one or more computers and one or more storage devices storing instructions that are operable, when executed by the one or more computers, to cause the one or more computers to perform operations comprising:
receiving a request for content, the request including request data;
accessing product data representing a plurality of product records, each product record associated with a different product;
applying a plurality of matching rules to each of the plurality of product records in order to identify a subset of product records satisfying the plurality of matching rules;
for each of the product records of the subset of product records satisfying the plurality of matching rules, generating a plurality of scores, each score representing the relevance of the product to the request based on the request data, and generating an aggregate score based on the plurality of scores;
selecting one or more of the product records based at least on the aggregate scores; and
serving a dynamic product content item in response to the request, the dynamic product content item featuring the products associated with the one or more selected product records.

13. The system of claim 12, wherein, for each product record of the subset of product records, generating a plurality of scores comprises:
generating a score representing a historical interaction of users with content items featuring the product associated with the product record.

14. The system of claim 12, wherein, for each product record of the subset of product records, generating a plurality of scores comprises:
generating a score representing historical interaction of users with one or more internet resources featuring the product associated with the product record.

15. The system of claim 12,
wherein the request data includes a location;
wherein the product records include locations; and
wherein, for each product record of the subset of product records, generating a plurality of scores comprises generating a score representing a proximity of the location included in the request data to at least one of the locations included in the product record.

16. The system of claim 12,
wherein the request data includes a location; and
wherein, for each product record of the subset of product records, generating a plurality of scores comprises generating a score representing a relevance of the product associated with the product record to an environmental condition associated with the location included in the request data.

17. The system of claim 12,
wherein the request data includes one or more keywords associated with at least one of (i) content of a webpage on which content items served in response to the request are to be presented and (ii) a search query, for which content items in response to the request are to be presented on a search results page responsive to the search query;
wherein each product record includes one or more keywords; and
wherein, for each product record of the subset of product records, generating a plurality of scores comprises generating a score representing a relevance of the one or more keywords included in the request data to the one or more keywords included in the product record.

18. A non-transitory computer-readable medium storing software comprising instructions executable by one or more computers which, upon such execution, cause the one or more computers to perform operations comprising:
receiving a request for content, the request including request data;
accessing product data representing a plurality of product records, each product record associated with a different product;
applying a plurality of matching rules to each of the plurality of product records in order to identify a subset of product records satisfying the plurality of matching rules;
for each of the product records of the subset of product records satisfying the plurality of matching rules, generating a plurality of scores, each score representing the relevance of the product to the request based on the request data, and generating an aggregate score based on the plurality of scores;
selecting one or more of the product records based at least on the aggregate scores; and
serving a dynamic product content item in response to the request, the dynamic product content item featuring the products associated with the one or more selected product records.

19. The medium of claim 18, wherein, for each product record of the subset of product records, generating a plurality of scores comprises:
generating a score representing a historical interaction of users with content items featuring the product associated with the product record.

20. The medium of claim 18,
wherein the request data includes a location;
wherein the product records include locations; and
wherein, for each product record of the subset of product records, generating a plurality of scores comprises generating a score representing a proximity of the location included in the request data to at least one of the locations included in the product record.
